(19) United States
(12) Patent Application Publication
(10) Pub. No.: US 2025/0208964 A1
(43) Pub. Date: Jun. 26, 2025

(54) Generative Artificial Intelligence-Based Random Test Generation Framework For Processor Verification

(71) Applicant: MediaTek Inc., Hsinchu City (TW)

(72) Inventors: Rishna Patteri, Bengalura KA (IN); Srinivasa Sudhakar Tipparaju, Bengalura KA (IN); Karun Kumar Talari, Bengalura KA (IN); Bijay Kumar Sharma, Bengalura KA (IN)

(21) Appl. No.: 18/981,457

(22) Filed: Dec. 14, 2024

(30) Foreign Application Priority Data
Dec. 21, 2023 (IN) 202321087767
Oct. 4, 2024 (IN) 202421075245

(51) Int. Cl. G06F 11/26

(52) U.S. Cl. CPC G06F 11/26

(57) ABSTRACT

Techniques pertaining to generative artificial intelligence (GAI)-based random test generation framework for processor verification are described. An apparatus generates one of more random test cases with an aid of a GAI-assisted random verification program (GRVP) framework. The apparatus also performs validation testing on a design of a processor using the one or more random test cases.

### CROSS REFERENCE TO RELATED PATENT APPLICATION(S)

The present disclosure claims the priority benefit of India Patent Applications No. 202321087767 and 202421075245, filed 21 Dec. 2023 and 4 Oct. 2024, respectively, the contents of which being herein incorporated by reference in their entirety.

### TECHNICAL FIELD

The present disclosure is generally related to wireless communications and, more particularly, to generative artificial intelligence (GAI)-based random test generation framework for processor verification.

### BACKGROUND

Unless otherwise indicated herein, approaches described in this section are not prior art to the claims listed below and are not admitted as prior art by inclusion in this section.

In the context of integrated circuit (IC) design and verification of microprocessors (herein interchangeably referred to as “processors”), certain conventional methods have been utilized for processor verification test generations. Such conventional methods involve the usage of, for example, random test generators (in programming languages such as C++, Python, and so on), Perl/Python template-based test generators, System Verilog (SV)/universal verification methodology (UVM)-based test generators, and manually directed C/Assembly tests. However, there tend to be limitations associated with the conventional methods. For instance, there tend to be limited diversity in test generation, potential blind spots in verification, limited automation, and time-consuming manual test suite creation.

Moreover, microprocessor without interlocked pipelined stages (MIPS) instruction set architecture (ISA) tend to consist of over 200 instructions, resulting in billions of possible combinations. While generating completely random test cases is beneficial, it may not cover realistic scenarios. Therefore, there needs to be a methodology that focuses more on realistic scenarios within an infinite set of randomizations. At the time of the present disclosure, most random test suite generation utilities are specific to processors. However, there are very few processor-independent test suite generation utilities currently available that can be used across register transfer level (RTL) design verification (DV), simulators, and field programmable gate array (FPGA) validation. Examples of such test suites include compliance tests and benchmark programs. In general, each system maintains its own test suites, including boot code tailored for specific applications. For instance, FPGAs/silicon (Si) need to run larger applications and operating systems (OS), which tends to be difficult to achieve in RTL simulation due to longer run times. However, existing solutions primarily focus on compiler validation and lack instruction-based self-checking capabilities (e.g., Csmith using only cyclic redundancy check (CRC)-based checking). Additionally, they generate complex codes that may be difficult to understand.

In view of the above, there is a need for a solution of GAI-based random test generation framework for processor verification.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to GAI-based random test generation framework for processor verification. It is believed that implementations of the various proposed schemes may address or otherwise alleviate the aforementioned issue(s). Implementations of the proposed schemes may provide a smart framework for processor verification aimed to achieve goals including, for example, automation of test sequence generation, intelligent selection of functions covering a wide range of scenarios, and leveraging GAI, retrieval augmented generation (RAG) and conventional methods.

Under the proposed schemes, a method may involve a processor of an apparatus generating one of more random test cases with an aid of a GAI-assisted random verification program (GRVP) framework. The method may also involve the processor performing validation testing on a design of a processor using the one or more random test cases.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example framework in which various proposed schemes in accordance with the present disclosure may be implemented.

FIG. 2 is a diagram of an example framework under a proposed scheme in accordance with the present disclosure.

FIG. 3 is a diagram of an example procedure under a proposed scheme in accordance with the present disclosure.

FIG. 4 is a diagram of an example model under a proposed scheme in accordance with the present disclosure.

FIG. 5 is a diagram of an example scenario under a proposed scheme in accordance with the present disclosure.

FIG. 6 is a diagram of an example model under a proposed scheme in accordance with the present disclosure.

FIG. 7 is a diagram of an example scenario under a proposed scheme in accordance with the present disclosure.

FIG. 8 is a block diagram of an example apparatus under a proposed scheme in accordance with the present disclosure.

FIG. 9 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to GAI-based random test generation framework for processor verification. According to the present disclosure, a number of possible solutions may be implemented separately or jointly. That is, although these possible solutions may be described below separately, two or more of these possible solutions may be implemented in one combination or another.

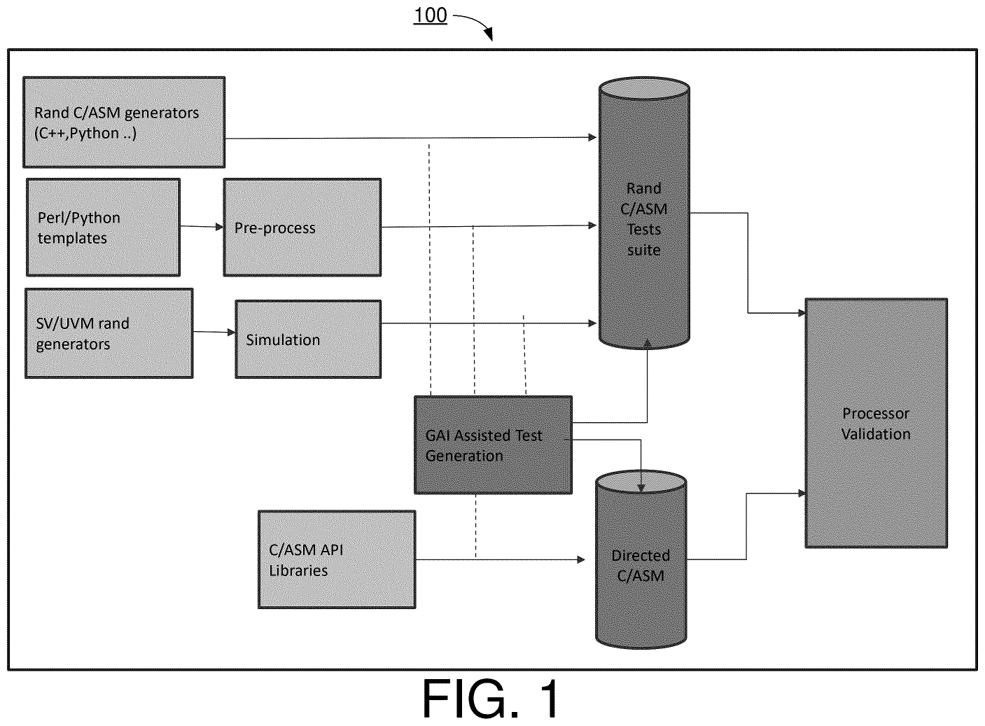

FIG. 1 illustrates an example framework 100 in which various proposed schemes in accordance with the present disclosure may be implemented. Under a proposed scheme in accordance with the present disclosure, conventional test suites may be enhanced with GAI. For example, a novel framework such as framework 100 may utilize a GAI-based random verification program (GRVP) framework to create random C/Assembly-language test cases for processor verification/validation with the help of GAI. Moreover, RAG-based reference libraries and learning examples with application programming interfaces (APIs) may generate powerful random test programs in C/Assembly language(s). Additionally, templates may be used to guide GAI to generate a test which has some portion as directed and the rest being random. Under the proposed scheme, GRVP framework and common libraries may be utilized to create interesting test sequences. Existing infrastructures may also be used to aid in identifying incremental changes required for new version(s) of projects. Furthermore, GAI may also be used in generating detailed documentation of code comments generated test cases, and GAI may randomly select some functions from a given library in a meaningful way.

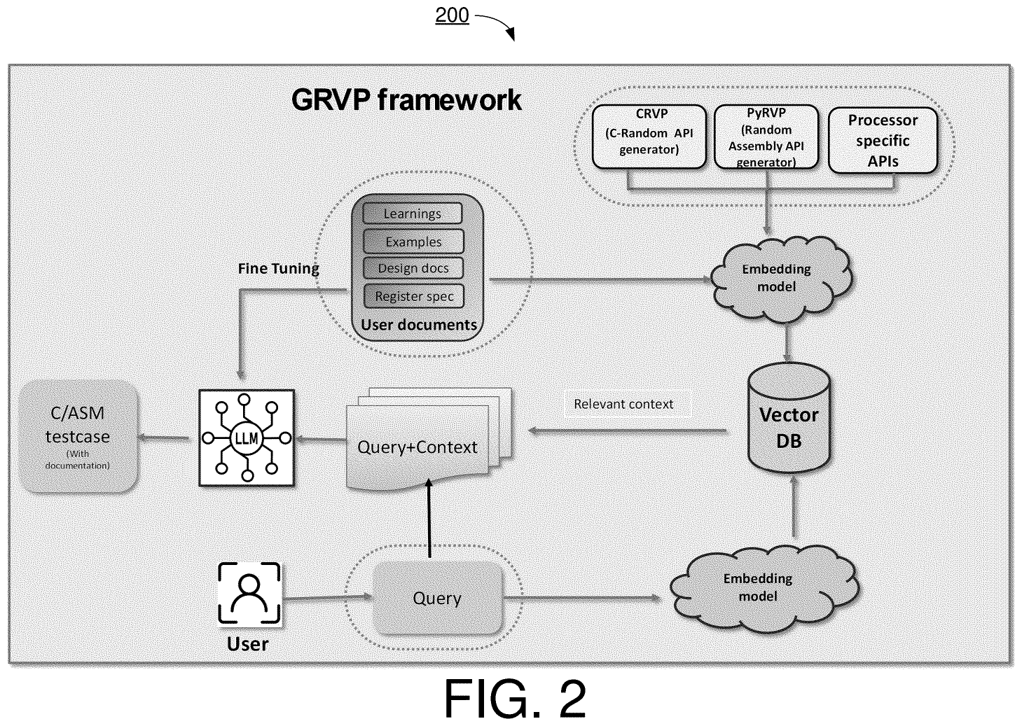

FIG. 2 illustrates an example framework 200 under a proposed scheme in accordance with the present disclosure. Framework 200 may be a GRVP framework under the proposed scheme. GRVP may be a GAI-powered common test infrastructure for processor design validation, offering processor-specific automatic test generation with GAI support for control and status register (CSR) operations, microprocessor unit (MPU) programming, and cache operations. In some implementations, the GRVP framework may encompass C-based ISA-independent random test generation, or C or C++-based random verification program (CRVP), for systems such as simulators/reference models, RTL verification, FPGA/emulation/Si bring-up, and compilers along with Python-based random test suit generation, or Python-based random verification program (PyRVP), for ISA-dependent features. Emphasizing realistic scenarios and real-time stimulus, the GRVP framework may feature a novel random expression layer for comprehensive arithmetic coverage, thereby surpassing solutions like Csmith with self-checks for each expression. Additionally, the GRVP framework may incorporate processor-dependent static parts and allow the addition of direct test cases for specific features and error scenarios during RTL simulation.

Referring to FIG. 2, the GRVP framework may be utilized to generate random test cases using GAI. A retrieval augmented generator (RAG) in the GRVP framework may combine large language models (LLMs) with a learning database to improve their output. The learning database may include user inputs like learning documents, register specifications and programming examples. Apart from learning documents, processor-specific APIs and/or libraries may also be fed to RAG along with random testcase generated using C-Random API generator, CRVP, Random Assembly API generator, and PyRVP to improve efficiency of random test case generation. Under the proposed scheme, GRVP-based tests may enhance the quality of design by exploring corner scenarios with the assistance of GAI.

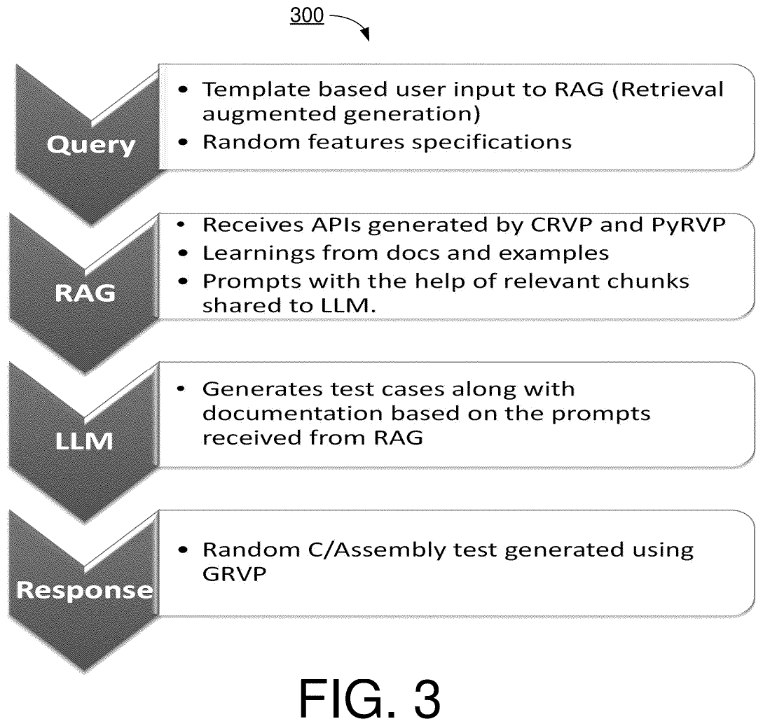

FIG. 3 illustrates an example procedure 300 under a proposed scheme in accordance with the present disclosure. Procedure 300 may pertain to an implementation of the GRVP framework. Referring to FIG. 3, procedure 300 may involve training of an LLM using documentation and providing template-based user input to the RAG for random feature specifications. Procedure 300 may involve RAG performing certain operations such as, for example and without limitation, receiving APIs generated by CRVP and/or PyRVP, learning from documentations and examples, and prompting with the help of relevant chunks shared to LLM. For instance, the RAG may process the input by receiving APIs generated by CRVP and PyRVP, and the RAG may incorporate additional information from learning documents. The RAG may then prompt the LLM with relevant chunks to generate test cases and documentation. In response to the prompting by RAG, the LLM may generate random C/Assembly test cases along with documentation based on the prompts received from RAG. The template output may serve as the input for creating tokens in the RAG architecture. The user prompt, along with relevant context from RAG, may be utilized by the fine-tuned LLM to generate the test cases.

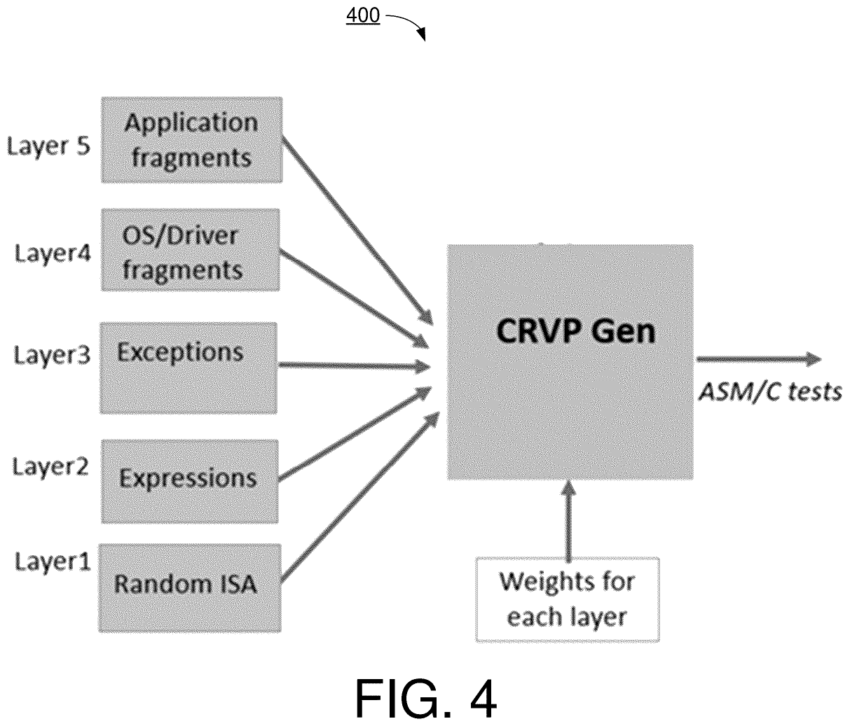

FIG. 4 illustrates an example CRVP model 400 under a proposed scheme in accordance with the present disclosure. Referring to FIG. 4, a CRVP generator of the CRVP model 400 may be utilized to generate C-based random APIs for arithmetic operations, logical operations, and so on. Most of the generated codes may be ISA-independent and, hence, may be used for validation design of many embedded processors. Many algorithms may have expressions as building blocks. The CRVP generator may create any random expressions of a higher order such as, for example, x+3y+z>>1 and (x \hat{ }y) & z. Known values may be fed to the CRVP generator to calculate outputs. The CRVP generator may generate self-checkable codes that may be used across systems like simulators, RTL, FPGA. The self-checking mechanism may add a good sense of reliability. Moreover, ISA-dependent codes may be added, in case that a user may be interested to insert some directed codes.

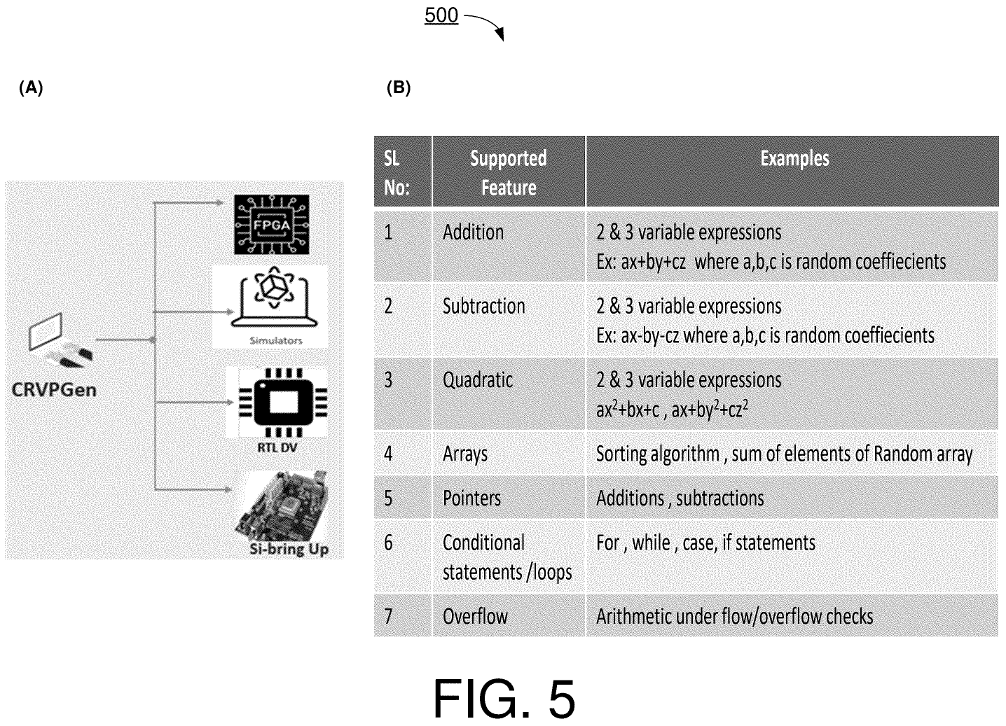

FIG. 5 illustrates an example scenario 500 under a proposed scheme in accordance with the present disclosure. Scenario 500 may pertain to a CRVP generator under the proposed scheme. Part (A) of FIG. 5 shows an example of potential applications of the CRVP generator. Part (B) of FIG.>5 shows an example of supported features of the CRVP generator and corresponding examples. Under the proposed scheme, the CRVP generator may be a tool written in C++ and it may generate C-random verification programs for processor design validation. Most of the generated codes may be ISA independent and may be used to validate many embedded processors. Under the proposed scheme, the CRVP generator may generate self-checkable codes that may be used across systems such as simulators/reference models, RTL verification, FPGA/emulation/Si bring-up, and compilers. In some implementations, ISA-dependent codes may be added. Such feature may help improve the quality analysis (QA) of reference models and may reduce dependency on them when used in RTL simulation. The methodology may focus on implementing more realistic scenarios within an infinite set of randomizations. In addition, the CRVP generator may allow running fragments of applications and Linux OS code while creating expressions that are part of real-time stimulus. Thus, the CRVP generator may be a promising tool for automatic test generation that may be used to verify and validate any embedded central processing unit (CPU). The self-checking mechanism may also add a sense of reliability.

In operation, the CRVP generator may run application/OS fragments on simulators and collect snapshots of input and output registers, CSRs, and so on. At an expression layer, as many algorithms may have expressions as building blocks, the CRVP generator may create any random expression of a higher order (e.g., x+3y+z>>1 and (x \hat{ }y) & z). Known values may be fed into the CRVP generator to calculate outputs. The GAI may utilize a learning database to ensure to stop repeated code(s) and generate unique sequences. The GAI may read few real-time drivers and applications to generate stimulus in random tests.

Accordingly, the CRVP generator in the CRVP model 400 may provide a multitude of benefits. For instance, a novel random expression layer implementation may become possible, allowing creation of random expressions up to an order of 4 with self-checking. This may ensure better coverage of various arithmetic operations. Additionally, existing solutions such as Csmith tend to use transparent CRC checks at definite intervals. In contrast, the CRVP generator may provide self-checking for each expressions, while Csmith requires a host machine to validate the CRC checks. Moreover, the CRVP generator may provide inherent self-checks that avoid requirements of host machine/reference models. Accordingly, the CRVP generator may be a better solution for processor design validation. Furthermore, the CRVP generator allows the usage of GAI to achieve more real-time stimulus. The usage of a learning database may also prevent repeated expressions.

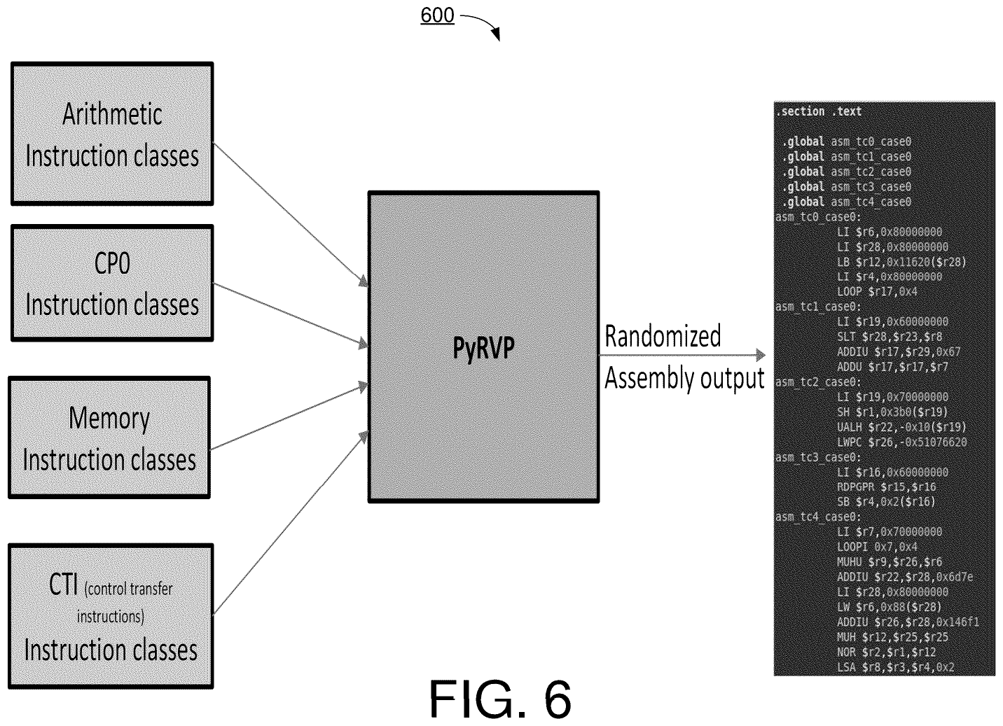

FIG. 6 illustrates an example PyRVP model 600 under a proposed scheme in accordance with the present disclosure. Referring to FIG. 6, a PyRVP generator of the PyRVP model 600 may be utilized to generate random assembly APIs specific to a given processor, including small features unique to the processor. Under the proposed scheme, the PyRVP generator may be an architecture dependent (MIPS) random assembly generator that takes input from different instruction classes and outputs an assembly program with complete random instruction. The PyRVP model 600 may be used to generate highly complex real-time stimulus to next-generation CPUs. The self-checking mechanism for each instruction, where the expected value of the operation are checked and where the device under test (DUT) is validated, may add a good sense of reliability to the model.

Under a proposed scheme in accordance with the present disclosure, a RAG may utilize the APIs generated by CRVP and/or PyRVP, along with additional information from learnings and design documents. The RAG may prompt with the help of relevant chunks shared to LLM. The LLM may generate test cases along with documentation based on the prompts received from RAG.

In view of the above, it may be summarized that the proposed schemes may provide multiple novelty features and benefits including, for example and not limited to, RAG, diverse test scenarios, quick bug identification, faster coverage, and documentation generation. Regarding RAG, the RAG may integrate reference libraries and learning examples with APIs to enhance the generation of diverse and powerful random test programs. Regarding diverse test scenarios, the GAI with RAG may facilitate the generation of diverse corner test cases, covering a wide range of scenarios for comprehensive verification. Regarding quick bug identification, the proposed schemes may enable quick identification of bugs in CPU/processor designs by generating targeted test scenarios that stress critical corner cases. Regarding faster coverage, the proposed schemes may provide faster coverage of critical corner cases compared to conventional methods, thereby enhancing the efficiency of verification process. Regarding documentation generation, the GRVP framework may help in documentation of the random generated code for test cases, thereby aiding the understanding and maintenance.

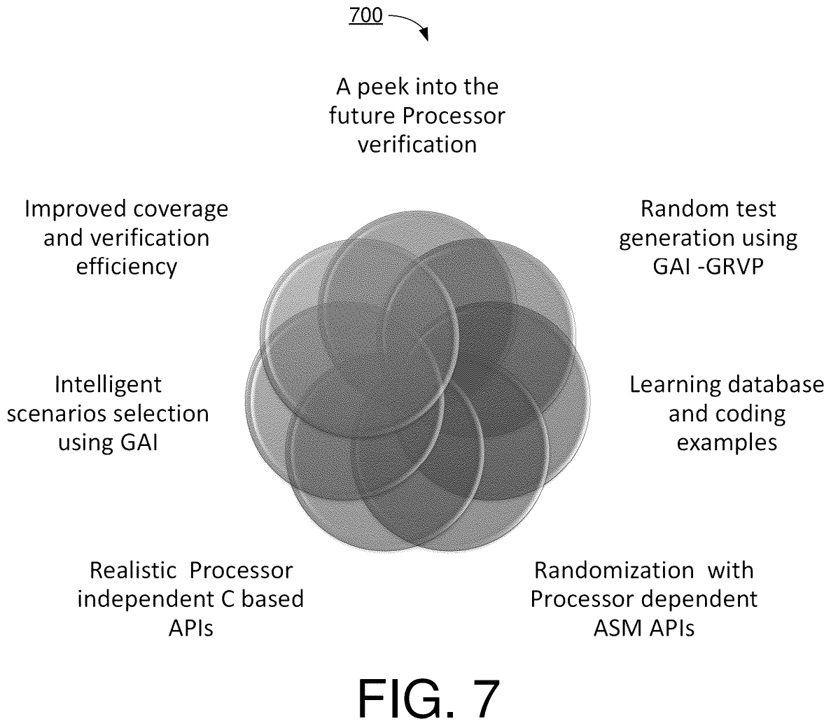

FIG. 7 illustrates an example scenario 700 under a proposed scheme in accordance with the present disclosure. Scenario 700 may pertain to advantages of implementing the GRVP described above. FIG. 7 lists some of the advantages of implementing a methodology under the proposed schemes for verification of next-generation processors. The use of GAI along with RAG in the GRVP framework may enable random test generation using robust learning and coding examples. This approach may incorporate added randomization with processor-dependent Assembly-language APIs and realistic, processor-independent C-based APIs for CPU verification. Intelligent scenario selection may also enhance coverage and verification efficiency, promising a transformative evolution in processor verification methodologies.

### Illustrative Implementations

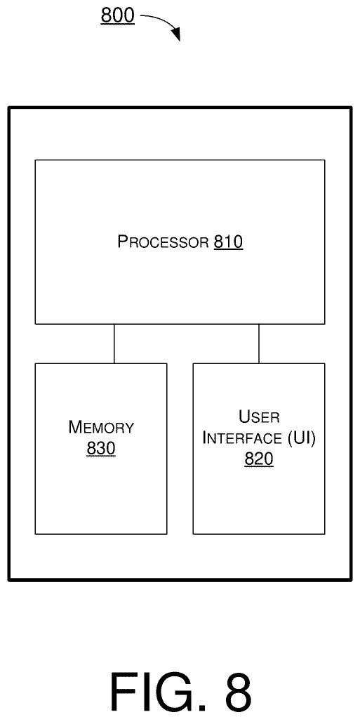

FIG. 8 illustrates an example apparatus 800 in accordance with an implementation of the present disclosure. Apparatus 800 may perform various functions to implement schemes, techniques, processes and methods described herein pertaining to GAI-based random test generation framework for processor verification, including the various schemes described above with respect to various proposed designs, concepts, schemes, systems and methods described above, including framework 100, framework 200, procedure 300, model 400 and model 600, as well as processes described below.

In some implementations, apparatus 800 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Apparatus 800 may include at least some of those components shown in FIG. 8 such as a processor 810, for example. Apparatus 800 may further include one or more other components not pertinent to the proposed scheme of the present disclosure (e.g., internal power supply, display device and/or user interface device), and, thus, such component(s) of apparatus 800 are neither shown in FIG. 8 nor described below in the interest of simplicity and brevity.

In one aspect, processor 810 may be implemented in the form of one or more single-core processors, one or more multi-core processors, or one or more CISC or RISC processors. That is, even though a singular term “a processor” is used herein to refer to processor 810, processor 810 may include multiple processors in some implementations and a single processor in other implementations in accordance with the present disclosure. In another aspect, processor 810 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 810 is a special-purpose machine specifically designed, arranged and configured to perform specific tasks including those pertaining to GAI-based random test generation framework for processor verification in accordance with various implementations of the present disclosure.

In some implementations, apparatus 800 may further include a memory 830 coupled to processor 810 and capable of being accessed by processor 810 and storing data therein. Memory 830 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 830 may include a type of read-only memory (ROM) such as mask ROM, programmable ROM (PROM), erasable programmable ROM (EPROM) and/or electrically erasable programmable ROM (EEPROM). Alternatively, or additionally, memory 830 may include a type of non-volatile random-access memory (NVRAM) such as flash memory, solid-state memory, ferroelectric RAM (FeRAM), magnetoresistive RAM (MRAM) and/or phase-change memory.

In some implementations, apparatus 800 may also include a user interface (UI) device 820 coupled to processor 810. UI device 820 may be capable of receiving input (e.g., from a user or another apparatus, or retrieved from memory 830) and providing output (e.g., to the user or another apparatus, or storing in memory 830) in the form of information, data, instructions, programming codes, and so on.

For illustrative purposes and without limitation, a description of capabilities of apparatus 800 is provided below in the context of example process 900.

### Illustrative Processes

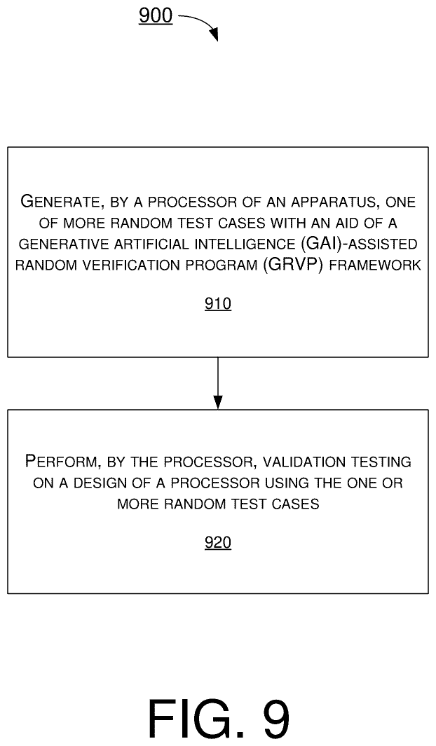

FIG. 9 illustrates an example process 900 in accordance with an implementation of the present disclosure. Process 900 may represent an aspect of implementing various proposed designs, concepts, schemes, systems and methods described above pertaining to GAI-based random test generation framework for processor verification, whether partially or entirely, including those pertaining to those described above. Process 900 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or alternatively in a different order. Furthermore, one or more of the blocks/sub-blocks of each process may be executed iteratively. Process 900 may be implemented by or in apparatus 800. Solely for illustrative purposes and without limiting the scope, each process is described below in the context of apparatus 800 functioning as a tool used in the design, verification/validation and/or testing of processor designs. Process 900 may begin at block 910.

At 910, process 900 may involve processor 810 of apparatus 800 generating one of more random test cases with an aid of a GRVP framework. Process 900 may proceed from 910 to 920.

At 920, process 900 may involve processor 810 performing validation testing on a design of a processor using the one or more random test cases.

In some implementations, in generating the one or more random test cases, process 900 may involve processor 810 utilizing an RAG in the GRVP framework to perform operations including: (a) receiving a template-based user input along with one or more random feature specifications; (b) receiving one or more APIs; (c) learning from documents and examples; and (d) prompting with an aid of relevant chunks shared to an LLM in the GRVP framework.

In some implementations, in generating the one or more random test cases, process 900 may further involve processor 810 additional operations. For instance, process 900 may involve processor 810 utilizing the LLM to generate one or more test cases along with documentation based on an input received from the RAG. Moreover, process 900 may involve processor 810 generating the one or more random test cases in a predefined language based on the one or more test cases generated by the LLM.

In some implementations, in utilizing the RAG, process 900 may further involve processor 810 utilizing the RAG to perform operations including: (a) utilizing the LLM to generate one or more test cases along with documentation based on the input received from the RAG; (b) integrating reference libraries; and (c) learning examples with the APIs to enhance generation of random test programs.

In some implementations, in generating the one or more random test cases, process 900 may further involve processor 810 utilizing a CRVP generator to generate the one or more APIs.

In some implementations, in generating the one or more random test cases, process 900 may further involve processor 810 utilizing the CRVP generator to generate one or more random verification programs in C that are used in validating the design of the processor. In some implementations, the one or more C-random verification programs may be ISA-independent.

In some implementations, in utilizing the CRVP generator to generate one or more C-random verification programs, process 900 may involve processor 810 utilizing the CRVP generator to perform operations including: (a) running application and OS fragments on simulators; (b) collecting snapshots of input and output registers and CSRs; (c) creating random expressions of an order of 3 or 4; and (d) calculating outputs using known values as inputs.

In some implementations, in generating the one or more random test cases, process 900 may further involve processor 810 utilizing a PyRVP generator to generate the one or more APIs. In some implementations, in generating the one or more random test cases, process 900 may further involve processor 810 utilizing the PyRVP generator to generate one or more random verification programs in Assembly that are used in validating the design of the processor.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, one or more random test cases with an aid of a generative artificial intelligence (GAI)-assisted random verification program (GRVP) framework; and
performing, by the processor, validation testing on a design of a processor using the one or more random test cases.

2. The method of claim 1, wherein the generating of the one or more random test cases comprises utilizing a retrieval augmented generator (RAG) in the GRVP framework to perform operations comprising:
receiving a template-based user input along with one or more random feature specifications;
receiving one or more application programming interfaces (APIs);
learning from documents and examples; and
prompting with an aid of relevant chunks shared to a large language model (LLM) in the GRVP framework.

3. The method of claim 2, wherein the generating of the one or more random test cases further comprises:
utilizing the LLM to generate one or more test cases along with documentation based on an input received from the RAG; and
generating the one or more random test cases in a predefined language based on the one or more test cases generated by the LLM.

4. The method of claim 2, wherein the utilizing of the RAG further comprises utilizing the RAG to perform operations comprising:
utilizing the LLM to generate one or more test cases along with documentation based on an input received from the RAG;
integrating reference libraries; and
learning examples with the APIs to enhance generation of random test programs.

5. The method of claim 2, wherein the generating of the one or more random test cases further comprises utilizing a C or C++-based random verification program (CRVP) generator to generate the one or more APIs.

6. The method of claim 5, wherein the generating of the one or more random test cases further comprises utilizing the CRVP generator to generate one or more random verification programs in C that are used in validating the design of the processor.

7. The method of claim 6, wherein the one or more C-random verification programs are instruction set architecture (ISA)-independent.

8. The method of claim 6, wherein the utilizing of the CRVP generator to generate one or more C-random verification programs comprises utilizing the CRVP generator to perform operations comprising:
running application and operating system (OS) fragments on simulators;
collecting snapshots of input and output registers and control and status registers (CSRs);
creating random expressions of an order of 3 or 4; and
calculating outputs using known values as inputs.

9. The method of claim 2, wherein the generating of the one or more random test cases further comprises utilizing a Python-based random verification program (PyRVP) generator to generate the one or more APIs.

10. The method of claim 9, wherein the generating of the one or more random test cases further comprises utilizing the PyRVP generator to generate one or more random verification programs in Assembly that are used in validating the design of the processor.

11. An apparatus, comprising:
a memory configured to store information, data and instructions; and
a processor coupled to the memory and configured to perform operations comprising:
generating one of more random test cases with an aid of a generative artificial intelligence (GAI)-assisted random verification program (GRVP) framework; and
performing validation testing on a design of a processor using the one or more random test cases.

12. The apparatus of claim 11, wherein the generating of the one or more random test cases comprises utilizing a retrieval augmented generator (RAG) in the GRVP framework to perform operations comprising:
receiving a template-based user input along with one or more random feature specifications;
receiving one or more application programming interfaces (APIs);
learning from documents and examples; and
prompting with an aid of relevant chunks shared to a large language model (LLM) in the GRVP framework.

13. The apparatus of claim 12, wherein the generating of the one or more random test cases further comprises:
utilizing the LLM to generate one or more test cases along with documentation based on an input received from the RAG; and
generating the one or more random test cases in a predefined language based on the one or more test cases generated by the LLM.

14. The apparatus of claim 12, wherein the utilizing of the RAG further comprises utilizing the RAG to perform operations comprising:
utilizing the LLM to generate one or more test cases along with documentation based on an input received from the RAG;
integrating reference libraries; and
learning examples with the APIs to enhance generation of random test programs.

15. The apparatus of claim 12, wherein the generating of the one or more random test cases further comprises utilizing a C or C++-based random verification program (CRVP) generator to generate the one or more APIs.

16. The apparatus of claim 15, wherein the generating of the one or more random test cases further comprises utilizing the CRVP generator to generate one or more random verification programs in C that are used in validating the design of the processor.

17. The apparatus of claim 16, wherein the one or more C-random verification programs are instruction set architecture (ISA)-independent.

18. The apparatus of claim 16, wherein the utilizing of the CRVP generator to generate one or more C-random verification programs comprises utilizing the CRVP generator to perform operations comprising:
running application and operating system (OS) fragments on simulators;
collecting snapshots of input and output registers and control and status registers (CSRs);
creating random expressions of an order of 3 or 4; and
calculating outputs using known values as inputs.

19. The apparatus of claim 12, wherein the generating of the one or more random test cases further comprises utilizing a Python-based random verification program (PyRVP) generator to generate the one or more APIs.

20. The apparatus of claim 19, wherein the generating of the one or more random test cases further comprises utilizing the PyRVP generator to generate one or more random verification programs in Assembly that are used in validating the design of the processor.
